(19) United States
(12) Patent Application Publication
(10) Pub. No.: US 2015/0281679 A1
(43) Pub. Date: Oct. 1, 2015

(54) PIXEL DATA GENERATION FOR AUTOSTEREOSCOPY IMAGES

(71) Applicant: QUALCOMM Incorporated, San Diego, CA (US)

(72) Inventors: Phi Hung Le Nguyen, San Diego, CA (US); Bijan Forutanpour, San Diego, CA (US); Ning Bi, San Diego, CA (US)

(73) Assignee: QUALCOMM Incorporated, San Diego, CA (US)

(21) Appl. No.: 14/229,124

(22) Filed: Mar. 28, 2014

(51) Int. Cl. H04N 13/04; G06T 1/20

(52) U.S. Cl. CPC H04N 13/0402; H04N 13/0422; G06T 1/20

(57) ABSTRACT

Techniques are described for generating autostereoscopy content. A graphics processing unit (GPU) may determine from which views to retrieve pixel data, and may read the pixel data from corresponding images of only the determined views. In this manner, the techniques may promote efficiency in the generation of autostereoscopy content.

### TECHNICAL FIELD

This disclosure relates to graphics data processing, and more particularly, to graphics data processing for autostereoscopy content.

### BACKGROUND

Stereoscopic view refers to a perceived image that appears to encompass a 3-dimensional (3D) volume. To generate the stereoscopic view, a display device displays a plurality of images substantially at a same time on a 2-dimensional (2D) area of a display. These plurality of images include similar content, but with slight displacement along the horizontal axis of one or more corresponding pixels in the images. The simultaneous viewing of these images, on a 2D area, causes a viewer to perceive an image that extends out of or recedes into the 2D display that is displaying the images. In this way, although the images are displayed on the 2D area of the display, the viewer perceives an image that appears to encompass the 3D volume.

Autostereoscopy refers to a viewer perceiving stereoscopy effect without necessarily needing specialized viewing gear. For autostereoscopy, images from different views are blended together and outputted to the display devices. For instance, if there are eight views, images from each of the views that are to be displayed at substantially a same time are blended together to form a blended image. In this example, there are eight “sweet spots,” where a sweet spot refers to a location from where viewer can view the display device and experience high quality stereoscopy effect. The number of sweet spots may equal the number of views.

### SUMMARY

In general, the disclosure describes techniques for generating autostereoscopy content where a graphics processing unit (GPU) reads the color components of pixels from only the views needed to generate the pixel data for a pixel of an autostereoscopy image. In this manner, the techniques may limit the number of instructions needed to read pixel data and limit the amount of pixel data that needs to be read and processed, resulting in more efficient generating of autostereoscopy content. For instance, the techniques may increase the efficiency of generating autostereoscopy content to such a level that mobile devices can generate the autostereoscopy content even though GPUs of the mobile devices may have limited processing capabilities and would not otherwise be capable of generating the autostereoscopy content in a timely fashion.

In one example, the disclosure describes a method of generating autostereoscopy content, the method comprising determining which subset of views from a plurality of views is needed for generating pixel data of a pixel of an autostereoscopy image, reading color components of pixels in corresponding images of only the subset of views after determining which subset of views is needed for generating pixel data of the pixel of the autostereoscopy image, and generating, based on the read color components of the pixels in the corresponding images of the subset of views, the pixel data of the pixel of the autostereoscopy image.

In one example, the disclosure describes a device for generating autostereoscopy content, the device comprising a memory configured to store images of a plurality of views and a graphics processing unit (GPU). The GPU is configured to determine which subset of views from a plurality of views is needed for generating pixel data of a pixel of an autostereoscopy image, read color components of pixels in corresponding images of only the subset of views after determining which subset of views is needed for generating pixel data of the pixel of the autostereoscopy image, and generate, based on the read color components of the pixels in the corresponding images of the subset of views, the pixel data of the pixel of the autostereoscopy image.

In one example, the disclosure describes a computer-readable storage medium having instructions stored thereon that when executed cause a graphics processing unit (GPU) of a device for generating autostereoscopy content to determine which subset of successive views from a plurality of views is needed for generating pixel data of a pixel of an autostereoscopy image, wherein the subset of successive views comprise views with least amount of change in disparity in a particular direction compared to all other views, read color components of pixels in corresponding images of only the subset of successive views after determining which subset of successive views is needed for generating pixel data of the pixel of the autostereoscopy image, and generate, based on the read color components of the pixels in the corresponding images of the subset of successive views, the pixel data of the pixel of the autostereoscopy image.

In one example, the disclosure describes a device for generating autostereoscopy content, the device comprising a memory configured to store images of a plurality of view, and a graphics processing unit (GPU) comprising means for determining which subset of successive views from a plurality of views is needed for generating pixel data of a pixel of an autostereoscopy image, wherein the subset of successive views comprise views with least amount of change in disparity in a particular direction compared to all other views, means for reading color components of pixels in corresponding images of only the subset of successive views after determining which subset of successive views is needed for generating pixel data of the pixel of the autostereoscopy image, and means for generating, based on the read color components of the pixels in the corresponding images of the subset of successive views, the pixel data of the pixel of the autostereoscopy image.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example system to generate and display autostereoscopy content in accordance with one or more example techniques described in this disclosure.

FIG. 2A is a block diagram illustrating one example of the system of FIG. 1 in greater detail.

FIG. 2B is a block diagram illustrating another example of the system of FIG. 1 in greater detail.

FIG. 3 is a flowchart illustrating an example technique of generating autostereoscopy content in accordance with this disclosure.

FIG. 4 is a block diagram illustrating a device of FIG. 1 in further detail.

### DETAILED DESCRIPTION

Autostereoscopy allows a viewer to experience three-dimensional (3D) content without the need for specialized eyewear, such as special glasses. To display autostereoscopy content, the display device may need to be specially configured. For instance, Alioscopy of Paris, France is a company that produces autostereoscopy display devices that display 3D content without the user wearing specialized eyewear. To generate the autostereoscopy content, a graphics processing unit (GPU) blends corresponding images from multiple views and outputs the blended images to the autostereoscopy display device.

For autostereoscopy, there are multiple views and each view includes a set of images. An image in one view may include substantially similar image content as a corresponding image in another view. However, there may be slight disparity between the images. For example, a first image of a first view includes substantially similar image content as a first image of a second view, a first image of a third view, and so forth. However, in this example, there is horizontal disparity between corresponding viewable objects in the respective first images of the views. A second image of the first view includes substantially similar image content as the second image of the second view, the second image of the third view, and so forth. However, there is horizontal disparity between corresponding viewable objects in the respective second images of the views.

In some examples, the GPU that generates the autostereoscopy content may be a GPU with high processing capabilities (e.g., GPUs that operate at a high frequency that can process an extremely vast amount of data in parallel and read/write data relatively quickly). Some techniques that use such a high power and high processing GPU are inefficient in reading image content data needed for blending. However, because these techniques that use high power and high processing GPUs, the inefficiencies in reading in image content data have minimal effect. For example, a set-top box connected to an autostereoscopy display device may generate the autostereoscopy content. Because the set-top box includes a high power and high processing GPU, the inefficient reading of image content data for generating autostereoscopy content may be of no consequence.

However, for GPUs on mobile devices, such as wireless handsets, tablets, etc., inefficient reading of image content data needed for blending may make mobile devices unsuitable for generating autostereoscopy content. For instance, GPUs on mobile devices may not provide as much processing capabilities as compared to GPUs on other types of devices. For example, GPUs on mobile devices not be as efficient at reading and writing data as compared to GPUs with high processing capabilities. Using techniques similar to those used by GPUs on these other types of device for generating autostereoscopy content may not be feasible with GPUs on mobile devices.

In general, using GPUs with high processing capabilities requires high power, and such power may not be available on a mobile device or may be at a premium. Accordingly, using a GPU on a device where significant power resources are available in a mobile device may not be possible. Therefore, mobile devices may not be well-suited for generating autostereoscopy content using some other techniques.

The techniques described in this disclosure describe example ways to generate autostereoscopy content via GPUs on mobile devices. This may allow the mobile device to connect to an autostereoscopy display device and output the generated autostereoscopy content on the autostereoscopy display device, which may otherwise not be feasible if techniques such as those used by high power GPUs are used to generate the autostereoscopy content.

In some cases, reading pixel data for corresponding images of different views (referred to as texture reads) is generally a slow process on GPUs of mobile devices (i.e., requires many processing cycles). As described in more detail, with the techniques described in this disclosure, a GPU may be able to read the minimum amount of pixel data needed to render a pixel of the autostereoscopy display device. By minimizing the amount of pixel data needed to render a pixel of the autostereoscopy display device, even a GPU of a mobile device may be able to generate autostereoscopy content.

Furthermore, although the techniques described in this disclosure are described from the perspective of GPUs on a mobile device, the techniques described in this disclosure are not so limited. For instance, the techniques described in this disclosure may be advantageous even for GPUs on other types of devices because the techniques may promote efficient reading of pixel data. For example, GPUs on non-mobile devices may already be configured to generate autostereoscopy content, and such GPUs may be able to generate autostereoscopy content in a more efficient manner utilizing the techniques described in this disclosure. Some GPUs on mobile devices may not have been able to generate autostereoscopy content, but may be able to use the techniques described in this disclosure.

To generate the autostereoscopy content (e.g., an autostereoscopy image), the GPU may need to read pixel data from no more than three images to render a pixel of the autostereoscopy display device, where each of the three images is from respective ones of three successive views. As described in more detail below, in one example, a graphics shader program (e.g., a fragment shader) executing on the GPU may determine from which views to read pixel data, using branching commands (e.g., if-then-else commands), for a particular pixel of the autostereoscopy image. As also described in more detail below, in another example, the graphics shader program may read pre-stored information from which the graphics shader program may determine which views to read pixel data for a particular pixel of the autostereoscopy image.

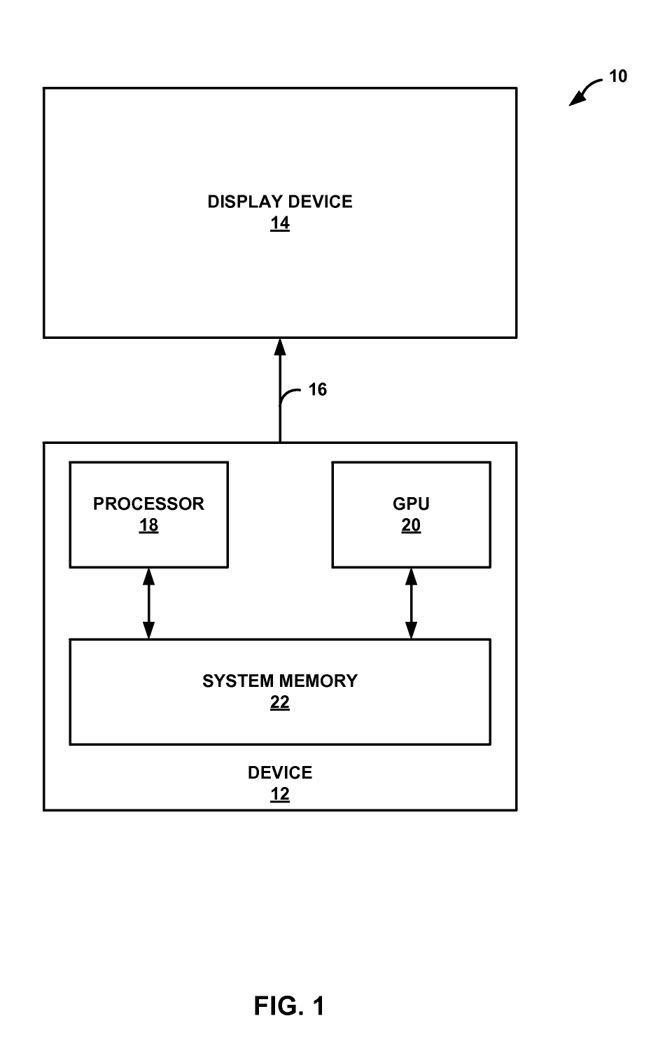

FIG. 1 is a block diagram illustrating an example system to generate and display autostereoscopy content in accordance with one or more example techniques described in this disclosure. As illustrated, system 10 includes device 12 and display device 14 that are connected with computer-readable medium 16. Examples of device 12 include, but are not limited to, video devices such as media players, set-top boxes, wireless handsets such as mobile telephones, personal digital assistants (PDAs), desktop computers, laptop computers, gaming consoles, video conferencing units, tablet computing devices, and the like. For purposes of illustration, device 12 may be considered a mobile device such as a mobile telephone (e.g., a so-called smart-phone), a tablet computing device (e.g., a tablet), a laptop computer, or another type of computing device designed for mobility.

Display device 14 may be a type of display device configured to output autostereoscopy content. For example, display device 14 is a display device where a viewer, without the aid of specialized eyewear, perceives the displayed content as if is extending outwards or inwards relative to display device 14 so that the content encompasses a three-dimensional volume. One example of display device 14 is a display device marketed by Alioscopy. However, the techniques described in this disclosure should not be considered limited to display devices marketed by Alioscopy. Because display device 14 is configured to output autostereoscopy content, display device 14 may be referred to as an autostereoscopy display device.

In at least some techniques described in this disclosure, device 12 generates autostereoscopy content (e.g., images that when rendered by display device 14 cause a viewer to perceive 3D content without needing specialized eyewear) and outputs the pixel data of each autostereoscopy image to display device 14 via computer-readable medium 16. Computer-readable medium 16 may comprise a type of medium or device capable of moving the autostereoscopy content from device 12 to display device 14.

In one example, computer-readable medium 16 comprises a communication medium to enable device 12 to transmit pixel data of autostereoscopy images (e.g., autostereoscopy content) directly to display device 14 in real-time. For example, computer-readable medium 16 may comprise a High-Definition Multimedia Interface (HDMI) cable. In general, the communication medium of computer-readable medium 16 may comprise a wireless or wired communication medium, such as a radio frequency (RF) spectrum or one or more physical transmission lines.

In some examples, device 12 may output autostereoscopy content (e.g., pixel data of the autostereoscopy images) to a storage device (not illustrated in FIG. 1). Display device 14 may access the autostereoscopy content from the storage device. The storage device may include any of a variety of distributed or locally accessed data storage media, such as a hard drive, Blu-ray discs, DVDs, CD-ROMs, flash memory, volatile or non-volatile memory, or other suitable digital storage media for storing the content. Display device 14 may access the autostereoscopy content stored on the storage device through a standard data connection, such as a wireless channel (e.g., a Wi-Fi connection), a wired connection (e.g., HDMI cable, etc.), or a combination of both. The transmission of the autostereoscopy content from the storage device may be a streaming transmission, a download transmission, another type of transmission, or a combination thereof

In this manner, device 12 may output the autostereoscopy content to display device 14 for immediate or eventual display. In some examples, device 12 may be configured to output the autostereoscopy content to display device 14 as part of video streaming, video playback, video broadcasting, and/or video telephony. In some examples, device 12 may be configured to output the autostereoscopy content to display device 14 as part of gaming. For example, a user of device 12 may play a video game on device 12, and device 12 may generate autostereoscopy content from the graphics generated by the video game and output the autostereoscopy content to display device 14.

Although the techniques are described with respect to device 12 outputting the autostereoscopy content to display device 14, in some cases, device 12 itself may include a display capable of displaying autostereoscopy content. For example, it may be possible at some point to scale down display device 14 such that display device 14 is formed on device 12 including in examples where device 12 is a mobile device. In these examples, the display of device 12 may be considered as display device 14 that output autostereoscopy content generated in accordance with the techniques described in this disclosure.

In the example of FIG. 1, device 12 includes processor 18, graphics processing unit (GPU) 20, and system memory 22. In some examples, such as examples where device 12 is a mobile device, processor 18 and GPU 20 may be formed as an integrated circuit (IC). For example, the IC may be considered as a processing chip within a chip package. In some examples, processor 18 and GPU 20 may be housed in different integrated circuits (i.e., different chip packages) such as examples where device 12 is a desktop or laptop computer. However, it may be possible that processor 18 and GPU 20 are housed in different integrated circuits in examples where device 12 is a mobile device.

Examples of processor 18 and GPU 20 include, but are not limited to, one or more digital signal processors (DSPs), general purpose microprocessors, application specific integrated circuits (ASICs), field programmable logic arrays (FPGAs), or other equivalent integrated or discrete logic circuitry. In some examples, GPU 20 may be specialized hardware that includes integrated and/or discrete logic circuitry that provides GPU 20 with massive parallel processing capabilities suitable for graphics processing. In some instances, GPU 20 may also include general purpose processing capabilities, and may be referred to as a general purpose GPU (GPGPU) when implementing general purpose processing tasks (i.e., non-graphics related tasks).

Processor 18 may execute various types of applications. Examples of the applications include web browsers, e-mail applications, spreadsheets, video games, or other applications that generate viewable objects for display. System memory 22 may store instructions for execution of the one or more applications. The execution of an application on processor 18 causes processor 18 to produce graphics data for image content that is to be displayed. Processor 18 may transmit graphics data of the image content to GPU 20 for further processing.

For instance, processor 18 may offload processing tasks to GPU 20, such as tasks that require massive parallel operations. As one example, graphics processing requires massive parallel operations, and processor 18 may offload such graphics processing tasks to GPU 20. Processor 18 may communicate with GPU 20 in accordance with a particular application processing interface (API). Examples of such APIs include the DirectX® API by Microsoft®, the OpenGL® or OpenGL ES® by the Khronos group, and the OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and processor 18 and GPU 20 may utilize any technique for communication.

System memory 22 may be the memory for device 12. System memory 22 may comprise one or more computer-readable storage media. Examples of system memory 22 include, but are not limited to, a random access memory (RAM), an electrically erasable programmable read-only memory (EEPROM), flash memory, or other medium that can be used to carry or store desired program code in the form of instructions and/or data structures and that can be accessed by a computer or a processor.

In some aspects, system memory 22 may include instructions that cause processor 18 and/or GPU 20 to perform the functions ascribed in this disclosure to processor 18 and GPU 20. Accordingly, system memory 22 may be a computer-readable storage medium having instructions stored thereon that, when executed, cause one or more processors (e.g., processor 18 and GPU 20) to perform various functions. For example, as described in more detail elsewhere in this disclosure, a fragment shader executing on GPU 20 may perform the example techniques for generating autostereoscopy content. System memory 22 may store the instructions of such a fragment shader that cause GPU 20 to generate the autostereoscopy content in accordance with the example techniques described in this disclosure. As another example, an application executing on processor 18 creates the image content used to generate the autostereoscopy content (e.g., a video game executing on processor 18). System memory 22 may store the instructions of the application that executes on processor 18.

In some examples System memory 22 may be a non-transitory storage medium. The term “non-transitory” may indicate that the storage medium is not embodied in a carrier wave or a propagated signal. However, the term “non-transitory” should not be interpreted to mean that system memory 22 is non-movable or that its contents are static. As one example, system memory 22 may be removed from device 12, and moved to another device. As another example, memory, substantially similar to system memory 22, may be inserted into device 12. In certain examples, a non-transitory storage medium may store data that can, over time, change (e.g., in RAM).

As described above, for autostereoscopy, display device 14 displays an image blended together from corresponding images of different views (e.g., blending the first images of the views to generate a first autostereoscopy image, blending the second images of the views to generate a second autostereoscopy image, and so forth). In some examples, display device 14 may be pre-configured for N number of “sweet spots.” If a viewer is located at any one of the N sweet spots, the viewer experiences high quality autostereoscopy effect. If a viewer is located between sweet spots, the viewer may still experience an autostereoscopy effect, but the quality may be diminished.

The number of views that GPU 20 blends may equal the number of sweet spots. For example, if display device 14 is configured for eight sweet spots, there may be eight views whose images GPU 20 blends.

To produce an autostereoscopy effect, display device 14 may require that images of the views be blended in a specific manner. For example, the color of each pixel of the autostereoscopy image that is to be rendered on display device 14 may be defined by a red-component, a green-component, and a blue-component (RGB). The autostereoscopy image that is to be rendered on display device 14 encompasses the entirety of the display of display device 14. Therefore, the illumination of a pixel of display device 14 is based on the pixel data of the corresponding pixel of the autostereoscopy image.

In the techniques described in this disclosure, to generate the pixel data (e.g., RGB components) for a first pixel of the autostereoscopy image to be illuminated on display device 14, GPU 20 may read the pixel data of the first pixel of corresponding images from three views. In particular, GPU 20 may read a first color component (e.g., red-component) of the first pixel of an image of a first view, a second color component (e.g., green-component) of the first pixel of a corresponding image of a second view, and a third color component (e.g., blue-component) of the first pixel of a corresponding image of a third view.

GPU 20 may blend (e.g., combine) the first color component, the second color component, and the third color component that GPU 20 read to generate the pixel data for the pixel of the autostereoscopy image. For example, GPU 20 may set the first color component of the image from the first view as the first color component of the pixel of the autostereoscopy image, set the second color component of the image from the second view as the second color component of the pixel of the autostereoscopy image, and set the third color component of the image from the third view as the third color component of the pixel of the autostereoscopy image. In other words, the pixel data of any pixel of the autostereoscopy image to be displayed on display device 14 includes a plurality of color components (e.g., three color components: red, green, and blue), and each of the color components is based on respective color components of pixels in corresponding images of different views.

Reading in pixel data for images of different views may be a processing intensive task that slows the overall rendering time of generating the autostereoscopy image. The techniques described in this disclosure determine the exact views from which the pixel data is to be read so as to minimize the amount of reads that are needed.

For instance, some other techniques, read pixel data from all views and then determine from which views the pixel data is needed for generating the pixel data for a particular pixel of display device 14. Because these other techniques read pixel data from all views for determining the pixel data for a particular pixel even though only a few views may be needed for determining the pixel data for the particular pixel, such techniques may be inefficient at generating the autostereoscopy content.

In the techniques described in this disclosure, GPU 20 determines which subset of views (e.g., which three views) from a plurality of views are needed for generating pixel data of a pixel of an autostereoscopy image. GPU 20 reads color components of pixels in corresponding images of only the subset of views (e.g., only the three views) after determining which subset of views are needed for generating pixel data of the pixel of the autostereoscopy image. By first determining which views are needed and then reading in the pixel data only from the needed views for determining the pixel data for a particular pixel, the techniques described in this disclosure may promote efficient generation of autostereoscopy content, and the efficiency gains may be such that GPU 20 (e.g., a GPU of a mobile device) can generate the autostereoscopy content.

In some examples, GPU 20 may determine which subset of views are needed to determine the pixel data for a particular pixel of the autostereoscopy image to be displayed on display device 14 based on the number of views used to generate the autostereoscopy content. For example, for a first pixel of the autostereoscopy image, GPU 20 may combine a first of three color components (e.g., red component) of pixel data of a first pixel of an image of a first view, a second of three color components (e.g., green component) of pixel data of a first pixel of a corresponding image of a second view, and a third of three color components (e.g., blue component) of pixel data of a first pixel of a corresponding image of a third view. In this example, the first, second, and third views are successive views. For a second pixel of the autostereoscopy image, GPU 20 may combine a first of three color components of pixel data (e.g., red component) of the second pixel of the image of the second view, a second of three color components of pixel data (e.g., green component) of the second pixel of the third view, and a third of three color components of pixel data (e.g., blue component) of the second pixel of the fourth view, and so forth. In this example, the second, third, and fourth views are successive views.

In other words, the pixel data of pixel 0 for a first autostereoscopy image is based on pixel data of pixel 0 from a first image of view 0, a first image of view 1, and a first image of view 2, where the pixel data from each respective pixel 0 is one different color component of three color components. The pixel data of pixel 1 for the first autostereoscopy image is based on pixel data of pixel 1 from the first image of view 1, the first image of view 2, and a first image of view 3, where the pixel data from each respective pixel 1 is one different color component of three color components.

In the above example, for pixel 0, view 0, view 1, and view 2 may be successive views, and for pixel 1, view 1, view 2, and view 3 may be successive views. Successive views refer to views with the least amount of change in disparity in a particular direction compared to all other views. For example, the N views may be from the left-most view to the right-most view. If the left-most view is view 0 and the right-most view is view N−1, then the amount of rightward disparity between images of view 0 and view 1 may be less than the amount of rightward disparity between images of view 0 and any other view. The amount of rightward disparity between images of view 1 and view 2 may be less than the amount of rightward disparity between images of view 1 and any other view, and so forth.

Also, successive views, as used in this disclosure, wrap around. For example, if there are N views identified as view 0 to view N−1, then view 0 is successive to view N−1. For instance, even in this case, the amount of rightward disparity between images of view N−1 and view 0 may be less than the amount of rightward disparity between images of view N−1 and any other view.

As describes above, pixel 0 of the autostereoscopy image is based on pixel 0 of corresponding images from views 0, 1, and 2, and pixel 1 of the autostereoscopy image is based on pixel 1 of corresponding images from views 1, 2, and 3, and so forth. If there are N views, then pixel N−3 of the autostereoscopy image is based on pixel N−3 of corresponding images from views N−3, N−2, and N−1. Pixel N−2 of the autostereoscopy image is based on pixel N−2 of corresponding images from views N−2, N−1, and 0. Pixel N−1 of the autostereoscopy image is based on pixel N−1 of corresponding images from views N−1, 0, and 1. In this way, if there are N views identified as view 0 to view N−1, then the views used for determining pixel data for a particular pixel of the autostereoscopy image include three successive views.

In one example of the techniques described in this disclosure, GPU 20 may determine which subset of successive views of a plurality of views are needed for a particular pixel of the autostereoscopy image that is to be rendered on display device 14 based on the position of the pixel on display device 14 and the number of views. For example, GPU 20 may utilize the position of the pixel and the modulo operation to determine which views are needed for generating the pixel data of a particular pixel of the autostereoscopy image to be rendered on display device 14.

In these techniques, each of the views may be identified by a particular view value, also referred to as an index value. For example, if there are N views, then the view values may range from view 0 to view N−1. Also, as described above, the autostereoscopy image may encompass the entirety of the display area of display device 14, and therefore, a pixel of display device 14 is a pixel of the autostereoscopy image. In this example, a position value for each pixel of the autostereoscopy image may be sequentially ordered. For instance, the position value for the first pixel is pixel 0, the position value for the second pixel is pixel 1, the position value for the third pixel is pixel 2, and so forth for a first row. The pixel in the beginning of the second row is the next numbered pixel. In other words, the pixels may be identified by sequential position values in a raster fashion.

In one example, GPU 20 may divide the position value of a pixel by the number of views, and may determine one of the three views needed based on the remainder. As one example, assume there are eight views, then for the pixel with position value eight, GPU 20 may divide the position value 8 by the number of views (i.e., eight) for a value of one and a remainder of zero. In this example, GPU 20 may determine that the first view needed for the pixel with position value eight is view 0. Because the number of views needed for any pixel is three, and the views are successive, GPU 20 may determine that pixel data from pixels with position value 8 in corresponding images of views 0, 1, and 2 are needed to determine the pixel data for the pixel with position value eight in the autostereoscopy image.

As another example, for the pixel with position value 35, GPU 20 may divide 35 (e.g., the position value) by eight (e.g., the number of views) for a value of four and a remainder of three. In this example, GPU 20 may determine that the views needed to determine the pixel data for the pixel with position value 35 are views 3, 4, and 5. In particular, GPU 20 may combine the pixel data of different color components from pixels with position value 35 in corresponding images of views 3, 4, and 5. For example, GPU 20 may set a first color component of the pixel with position value 35 in an image in view 3 as the first color component of the pixel with position value 35 in the autostereoscopy image, a second, different color component of the pixel with position value 35 in an image in view 4 as the second color component of the pixel with position value 35 in the autostereoscopy image, and a third, different color component of the pixel with position value 35 in an image in view 5 as the third color component of the pixel with position value 35 in the autostereoscopy image.

In some examples, GPU 20 may determine one of the views using the modulo operation, and may be preprogrammed to determine the other two views. As described above, the three views used to determine the pixel data of a pixel of the autostereoscopy image are successive views. Accordingly, the remainder may identify one view, and GPU 20 may add one and two to determine the other two views respectively. If by adding the one or two, the resulting value is greater than N−1, GPU 20 may wrap around (e.g., by determining the modulo value again). For instance, if the first view is view 6 and there are eight views (e.g., view 0 to view 7), then GPU 20 may determine the next view to be view 7 by adding one to six. For the following view, GPU 20 may add two to six and the resulting value is eight. However, there are only view 0 to view 7, and so, GPU 20 may determine the remainder of eight divided by eight, which is zero. In this example, GPU 20 may determine that the following view is view 0.

In this sense, each view may be associated with an index value (e.g., the view index of the first view is 0, the view index of the second view is 1, and so forth). For ease of description, this disclosure may refer to the first view as view 0, the second view as view 1, and so forth. Therefore, the numerical identifier for a particular view, as used in this disclosure, is also the view index for that view.

In this manner, GPU 20 may be able to determine the exact views whose pixel data is to be read. For instance, GPU 20 may determine which subset of successive views (e.g., which three views) from a plurality of views (e.g., eight views) are needed for generating pixel data of a pixel of an autostereoscopy image. After determining which subset of successive views are needed, GPU 20 may read pixel data of pixels in corresponding images of only the determined views that correspond to the pixel in the autostereoscopy image (e.g., a first color component of a pixel in an image in the first view, a second color component of a pixel in a corresponding image in the second view, and a third color component of a pixel in a corresponding image in the third view). By minimizing the amount of data that needs to be read, GPU 20 may be able to generate the pixel data for the autostereoscopy image even on a mobile device where the processing capabilities of GPU 20 may be diminished as compared to the processing capabilities of GPUs on other device types (e.g., non-mobile devices).

In this example technique, GPU 20 may need to execute branching instructions to determine which views are needed, where the number of branching instructions equals the number of views. A branching instruction is an instruction in which there are different options for the next instruction that is executed. Examples of branching instructions include if/then/else instructions. For example, GPU 20 may execute an “if” command for each possible value of the view index. In the above example, there are eight views, and therefore, GPU 20 may execute eight “if” commands or seven “if” commands and one “else” command. The branching instructions are described in more detail below.

In the example of branching instructions, GPU 20 may need to perform three read operations for each pixel of the autostereoscopy image, one read operation for each color component for each pixel from each of the three corresponding images from the three different views. However, relying on branching instructions to determine the exact views from which color components need to be read is not necessary in every example.

In some examples, system memory 22 stores a pre-computed pixel index value for each pixel of the autostereoscopy image. As described above, the autostereoscopy image encompasses the display of display device 14, and therefore, system memory 22 may store a pre-computed pixel index value for each pixel of the display of display device 14. For example, system memory 22 may store a two-dimensional buffer array of view index values. The top-left location in the two-dimensional buffer array corresponds to the first pixel of the autostereoscopy image, the position to the right in the two-dimensional buffer array corresponds to the second pixel of the autostereoscopy image, and so forth. In some examples, system memory 22 stores the view index values for only the first of the three successive views that are needed for determining the pixel data of a pixel of the autostereoscopy image, or system memory 22 may store the view index values for all three of the successive views that are needed for determining the pixel data of a pixel of the autostereoscopy image.

In these examples, GPU 20 may read the two-dimensional buffer array for the view index value to determine the views needed for the pixel data of a pixel of the autostereoscopy image. In some examples, this two-dimensional buffer array may function as another image by GPU 20. For instance, GPU 20 may use the same read commands to read from the two-dimensional buffer array as GPU 20 may use to read the pixel data from the images.

In the examples where GPU 20 reads from the two-dimensional buffer, GPU 20 may perform four read operations for each pixel of the autostereoscopy image. For instance, GPU 20 may need to perform a first read operation to read the view index value(s) from the two-dimensional buffer array. GPU 20 may then perform three read operations, one read operation for each color component for each pixel from each of the three corresponding images from the three different views.

Accordingly, in one example technique, GPU 20 may perform three read operations with branching instructions, and in one example technique, GPU 20 may perform four read operations without branching instructions. While read operations may be processing intensive, executing branching instructions may also be more processing intensive than not using branching instructions.

Therefore, for certain types of GPUs that are better designed for branching instructions, GPU 20 performing three read operations with branching instructions to determine the exact views needed for determining the pixel data for a pixel of autostereoscopy image may provide greater efficiencies compared to GPU 20 performing four read operations without branching operations. For certain types of GPUs that are not well suited for branching instructions, GPU 20 performing four read operations without branching instructions to determine the exact views needed for determining the pixel data for a pixel of autostereoscopy image may provide greater efficiencies compared to GPU 20 performing three read operations with branching instructions. However, either technique for any type of mobile GPU may still provide overall efficiencies to allow the mobile GPU to generate autostereoscopy content.

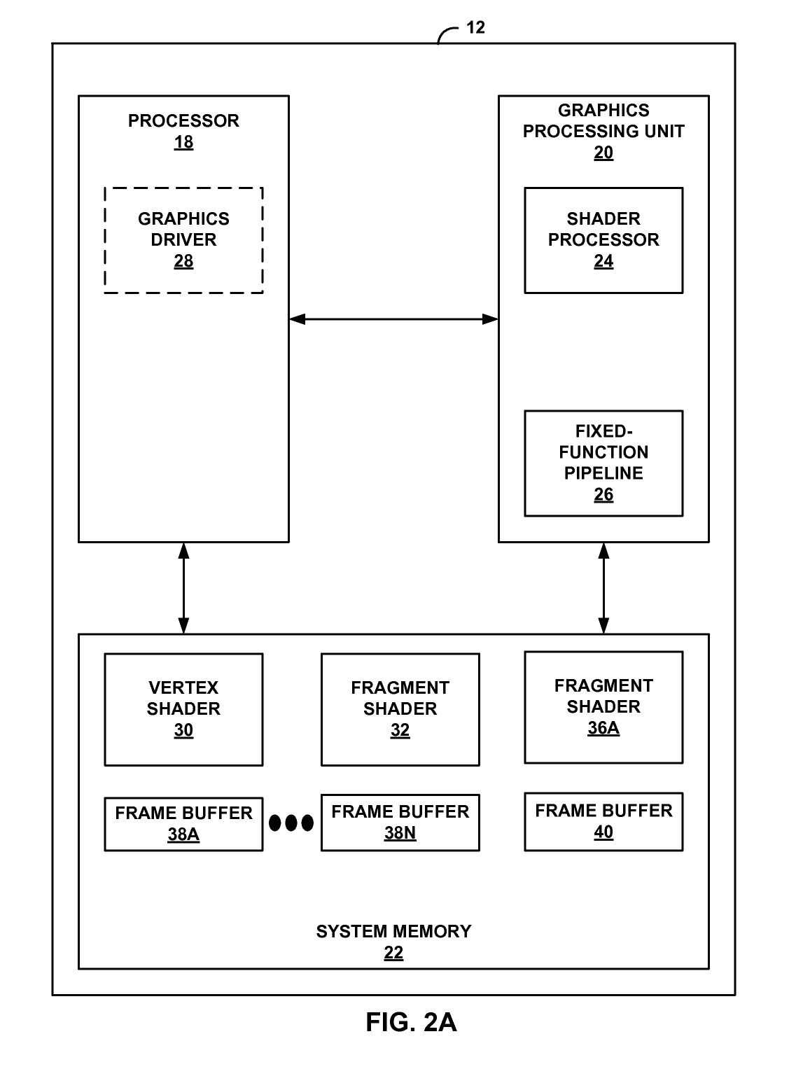

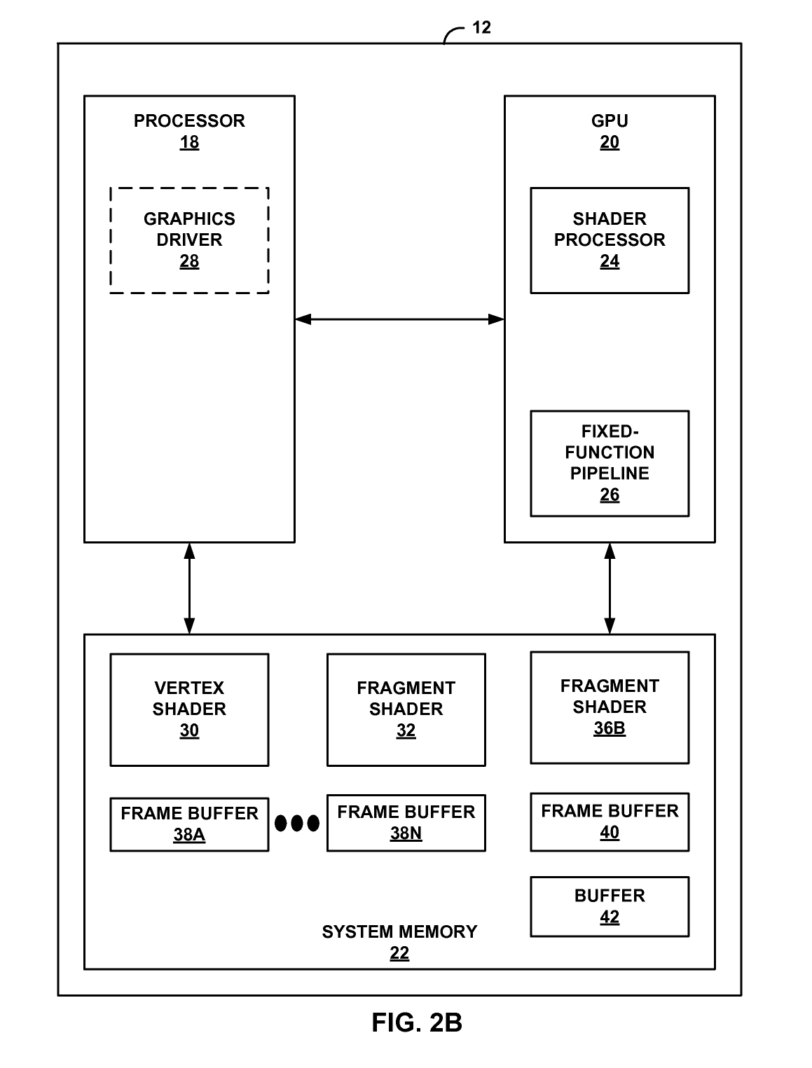

FIG. 2A is a block diagram illustrating one example of the system of FIG. 1 in greater detail. FIG. 2B is a block diagram illustrating another example of the system of FIG. 1 in greater detail. Because the examples illustrated in FIGS. 2A and 2B include many of the same units, FIGS. 2A and 2B are described together.

As illustrated in FIGS. 2A and 2B, GPU 20 includes shader processor 24 and fixed-function pipeline 26. Shader processor 24 and fixed-function pipeline 26 may together form a graphics processing pipeline used to perform graphics operation. The graphics processing pipeline performs functions as defined by software or firmware executing on GPU 20 and performs functions by fixed-function units that are hardwired to perform very specific functions.

The software or firmware executing on GPU 20 may be referred to as shader programs (or simply shaders), and the shader programs may execute on shader processor 24 of GPU 20 (e.g., one or more shader cores of GPU 20). Fixed-function pipeline 26 includes the fixed-function units. Shader processor 24 and fixed-function pipeline 26 may transmit and receive data from one another. For instance, the graphics processing pipeline may include shader programs executing on shader processor 24 that receive data from a fixed-function unit of fixed-function pipeline 26 and output processed data to another fixed-function unit of fixed-function pipeline 26.

Shader programs provide users with functional flexibility because a user can design the shader program to perform desired tasks in any conceivable manner. The fixed-function units, however, are hardwired for the manner in which the fixed-function units perform tasks. Accordingly, the fixed-function units may not provide much functional flexibility.

Examples of the shader programs include vertex shader 30, fragment shader 32, fragment shader 36A (FIG. 2A), and fragment shader 36B (FIG. 2B). There are additional examples of shader programs such as geometry shaders, which are not described for purposes of brevity. As described below, graphics driver 28 executing on processor 18 may be configured to implement an application programming interface (API). In such examples, the shader programs may be configured in accordance with the same API as graphics driver 28.

As one example, fragment shader 36A and 36B may be developed using GLSL of OpenGL or a kernel of OpenCL and may merge color components of pixels from corresponding images from views. A compiler may compile fragment shader 36A or 36B into machine instructions on device 12 that support these two APIs. It may be possible to retrieve the assembly instructions of the code using the compiler for test purposes such as eight images of different solid colors to test the reads or reads and branches.

Fragment shader 36A of FIG. 2A and fragment shader 36B of FIG. 2B may be different examples of fragment shaders because fragment shader 36A and fragment shader 36B may utilize different techniques to determine from which views to retrieve pixel data. However, it may be possible to develop one fragment shader 36 configured to implement both of the example techniques to determine from which views to retrieve pixel data, where such a fragment shader 36 selects from one of the example techniques based on the availability of texture buffer 42 (FIG. 2B). Texture buffer 42 is described in more detail below.

In some examples, system memory 22 may store the source code for one or more of vertex shader 30, fragment shader 32, fragment shader 36A, and fragment shader 36B. In these examples, a compiler (not shown) executing on processor 18 may compile the source code of these shader programs include object code executable by shader processor 24 of GPU 20 during runtime (e.g., at the time when these shader programs need to be executed on shader processor 24). In some examples, system memory 22 may store pre-compiled code (e.g., the object code) of these shader programs.

As illustrated, processor 18 may execute graphics driver 28. In FIGS. 2A and 2B, graphics driver 28 is software executing on processor 18. However, it may be possible for graphics driver 28 to be hardware units of processor 18 or a combination of hardware units and software executing on processor 18. Graphics driver 28 may be configured to allow processor 18 and GPU 20 to communicate with one another. For instance, when processor 18 offloads graphics processing tasks to GPU 20, processor 18 offloads graphics processing tasks to GPU 20 via graphics driver 28.

As an example, processor 18 may execute a gaming application that produces graphics data, and processor 18 may offload the processing of this graphics data to GPU 20. In this example, processor 18 may store the graphics data in system memory 22, and graphics driver 28 may instruct GPU 20 with when to retrieve the graphics data, from where to retrieve the graphics data in system memory 22, and when to process the graphics data. Also, the gaming application may require GPU 20 to execute one or more shader programs. For instance, the gaming application may require shader processor 24 to execute vertex shader 30 and fragment shader 32 to generate one of the images for one of the N views. Graphics driver 28 may instruct GPU 20 when to execute the shader programs and instruct GPU 20 with where to retrieve the graphics data needed for the shader programs. In this way, graphics driver 28 may form the link between processor 18 and GPU 20.

Graphics driver 28 may be configured in accordance to an API; although graphics driver 28 does not need to be limited to being configured in accordance with a particular API. In an example where device 12 is a mobile device, graphics driver 28 may be configured in accordance with the OpenGL ES API. The OpenGL ES API is specifically designed for mobile devices. In an example where device 12 is a non-mobile device, graphics driver 28 may be configured in accordance with the OpenGL API.

As illustrated in FIGS. 2A and 2B, system memory 22 includes frame buffer 38A to frame buffer 38N (referred to collectively as “frame buffers 38”). Each one of frame buffers 38 stores one or more images from respective views. For instance, frame buffer 38A stores an image of view 0, frame buffer 38B stores a corresponding image of view 1, and so forth. Again, corresponding images are images that are displayed at substantially similar times and have similar image content, but with disparity between objects in respective images.

There may be various different ways to generate the corresponding images of respective views that are stored in respective frame buffers 38, and the techniques described in this disclosure are not limited to any one particular way. As one example, the application executing on processor 18 may define camera parameters for each view, where the camera parameters define viewing position. This viewing position is not same as the viewing position of the viewer with respect to display device 14. Rather, this viewing position refers to a position of a hypothetical camera.

For instance, if eight cameras were arranged in a row, parallel to one another, each of the eight cameras would capture similar content, but with horizontal disparity between the images captured by the cameras. In some examples, the application executing on processor 18 may generate graphics data from the perspectives of each of these parallel cameras. It should be understood that in this example, there are not actual physical cameras; instead, the application executing on processor 18 generate graphics data from the perspective of cameras as if the cameras existed in specific viewing positions.

In this example, the application, via graphics driver 28, may instruct GPU 20 to render one image for each view based on the camera parameters. For instance, assume that the application generated graphics data from the perspective of eight hypothetical cameras arranged in a row. In this example, the application, via graphics driver 28, may instruct GPU 20 to render one image from the perspective of the first hypothetical camera in a first pass through the graphics processing pipeline, render one image from the perspective of the second hypothetical camera in a second pass through the graphics processing pipeline, and so forth until GPU 20 renders one image from the perspective of the eighth hypothetical camera in an eighth pass through the graphics processing pipeline. In this example, the number of hypothetical cameras equals the number of views.

After each pass through the graphics processing pipeline, GPU 20 may store the resulting rendered image in corresponding frame buffers 38. In this case, each rendered image is a two-dimensional image in the sense that if a person viewed any one of the rendered images by itself, the person would not perceive any autostereoscopy effect.

As one example, after the first pass through the graphics processing pipeline, GPU 20 may store the image generated from the perspective of the first camera in frame buffer 38A. In this example, GPU 20 may store the pixel data (e.g., red-component, green-component, blue-component, opacity values, etc.) of each of the pixels of the image for the first view. After the second pass through the graphics processing pipeline, GPU 20 may store the image generated from the perspective of the second camera in frame buffer 38B, and so forth. In this way, each one of frame buffers 38 may store a corresponding image. GPU 20 may store the pixel data of each of the pixels of each of images for the views in respective frame buffers 38.

For example, each respective one of frame buffers 38 comprises a respective two-dimensional buffer with each storage location in the two-dimensional buffers corresponding to a pixel of the stored image. For instance, the top-left storage location of frame buffer 38A may store the pixel data for the top-left pixel of an image of the first view, the top-left storage location of frame buffer 38B may store the pixel data for the top-left pixel of an image of the second view, and so forth. The storage location to the right of the top-left storage location of frame buffer 38A may store the pixel data for the pixel to the right of the top-left pixel of the image of the first view, the storage location to the right of the top-left storage location of frame buffer 38B may store the pixel data for the pixel to the right of the top-left pixel of the image of the second view, and so forth.

In some examples, display device 14 may require the blending of images from certain number of views (e.g., images from eight views). In examples where the application executing on processor 18 is configured to generate graphics data for the requisite number of views, GPU 20 may implement the techniques described in this disclosure from blending the images to generate the autostereoscopy image.

However, in some cases, the application executing on processor 18 may not be configured to generate graphics data for the requisite number of views. For instance, the application executing on processor 18 may be configured to generate graphics data for less than eight views, and in some cases, for only one view. In these examples, additional processing may be needed to generate additional views. There may be various ways to generate such additional views, and the techniques described in this disclosure are not limited to any particular technique to generating additional views. As one example, graphics driver 28 or a wrapper to graphics driver 28 may modify source code of vertex shader 30 to create the additional views. Such techniques are described in more detail in U.S. Publication No. 2012/0235999 A1, the entire contents of which are incorporated herein by reference. In these examples, GPU 20 may store the pixel data of each image of the generated views in corresponding frame buffers 38.

In some examples, it may even be possible to load images from different views directly into respective frame buffers 38. For example, it may be possible to capture video content from N number of cameras arranged in a row, and load the video content captured by each respective camera in each one of respective frame buffers 38.

In the examples where GPU 20 implements multiple passes of the graphics processing pipeline to generate the corresponding images stored in frame buffers 38, GPU 20 may execute vertex shader 30 and fragment shader 32. For instance, the application executing on processor 18 may cause processor 18, via graphics driver 28, to provide GPU 20 with the graphics data for rendering an image of the first view in the first pass through the graphics processing pipeline, and in this first pass, shader processor 24 may execute vertex shader 30 and fragment shader 32 with the graphics data for the image of the first view to render the image. The application executing on processor 18 may cause processor 18, via graphics driver 28, to provide GPU 20 with the graphics data for rendering a corresponding image of the second view in the second pass through the graphics processing pipeline, and in this second pass, shader processor 24 may execute vertex shader 30 and fragment shader 32 with the graphics data for the image of the second view to render the image, and so forth.

Once the corresponding images for the different views are stored in respective frame buffers 38, GPU 20 may selectively blend the images to generate the autostereoscopy image. For example, as described above, GPU 20 may determine which views (e.g., which successive views) are needed to determine the pixel data for a pixel of the autostereoscopy image.

Also, as described above, the autostereoscopy image may be the same size as that of display device 14. To ensure that pixel data is generated for all of the pixels of display device 14, processor 18, via graphics driver 28, may define a right triangle, where the right-angle corner of the right triangle corresponds to a corner of the autostereoscopy image, and the diagonal opposite corner of the autostereoscopy image corresponds to a point on the hypotenuse of the right triangle. Processor 18, via graphics driver 28, outputs this right triangle as a primitive to be processed by the graphics processing pipeline of GPU 20. Processor 18, via graphics driver 28, binds frame buffers 38 to this pass through the graphics processing pipeline as frame buffer objects (FBOs) so that pixel data for the images stored in frame buffers 38 is available for blending.

For instance, for N views, processor 18, via graphics driver 28, may cause GPU 20 to execute N passes of the graphics processing pipeline to generate pixel data for N corresponding images, where each image is for one of the N views. Processor 18, via graphics driver 28, may cause GPU 20 to execute an N+1 pass of the graphics processing pipeline. In the N+1 pass of the graphics processing pipeline, GPU 20 receives vertices of a triangle that encompasses the autostereoscopy image with access to frame buffers 38 so that GPU 20 can generate pixel data for each pixel of the autostereoscopy image by selectively combining color components of pixels in images in different views.

It should be understood that using a triangle that encompasses the autostereoscopy image in the N+1 pass of the graphics processing pipeline is one example way to ensure that GPU 20 generates pixel data for all of the pixels of the autostereoscopy image. However, the techniques described in this disclosure should not be considered so limited. There may be other ways to ensure that GPU 20 generates pixel data for all the pixels of the autostereoscopy image.

In some examples, reading the pixel data from frame buffers 38 may be considered as a “texture read.” In graphics processing, a texture read refers to reading of pre-stored two-dimensional data that is then mapped to the image to be rendered. In the techniques described in this disclosure, because frame buffers 38 store pixel data of images in two-dimensional storage form, GPU 20 reading from frame buffers 38 in the N+1 pass through the graphics processing pipeline may be considered as GPU 20 performing texture reads.

In FIG. 2A, in the N+1 pass through the graphics processing pipeline (i.e., the pass through the graphics processing pipeline for generating pixel data for the autostereoscopy image), GPU 20 may execute fragment shader 36A on shader processor 24 as instructed by graphics driver 28. In FIG. 2B, in the pass through the graphics processing pipeline for generating pixel data for the autostereoscopy image, GPU 20 may execute fragment shader 36B on shader processor 24 as instructed by graphics driver 28. Fragment shader 36A (FIG. 2A) and fragment shader 36B (FIG. 2B) may both be configured to generate the pixel data for pixels of the autostereoscopy image. However, fragment shader 36A and fragment shader 36B may implement different techniques to determine from which views to read the pixel data.

In FIGS. 2A and 2B, after GPU 20 performs the N+1 pass through the graphics processing pipeline, GPU 20 may output the resulting pixel data to frame buffer 40. In accordance with the techniques described in this disclosure, the pixel data stored in frame buffer 40 may be the pixel data for the autostereoscopy image. Device 12 may output the pixel data of the autostereoscopy image stored in frame buffer 40 to display device 14, via computer-readable medium 16, for display of the autostereoscopy image.

In some examples, frame buffer 40 may be a default frame buffer that is reserved to store the final image that is to be displayed. In these examples, graphics driver 28 may reserve additional memory space in system memory 22 for frame buffers 38. Accordingly, frame buffers 38 may store corresponding images that are blended together in accordance with the techniques described in this disclosure to generate an autostereoscopy image whose pixel data is stored in frame buffer 40. For instance, the techniques may combine together different color components of pixels from corresponding images stored in frame buffers 38 of different views together to generate the pixel data for the autostereoscopy image stored in frame buffer 40.

In the example illustrated in FIG. 2A, fragment shader 36A may determine the pixel position value of a pixel in the autostereoscopy image. Based on the pixel position value and the number of views needed to generate the autostereoscopy image, fragment shader 36A may determine a view index value, where the view index value refers to a particular view of the N views. For example, fragment shader 36A may utilize the modulo operation to determine the remainder of the division of the pixel position value with the number of views needed to generate the autostereoscopy image.

Fragment shader 36A may identify the pixel in an image of the view referenced by the view index value that is located in the same position as the pixel of the autostereoscopy image, and may read a color component of the identified pixel. Fragment shader 36A may be pre-programmed to identify pixels in corresponding images of the next two successive views after the view referenced by the view index value that are located in the same position as the pixel of the autostereoscopy image.

Fragment shader 36A may read a color component of the identified pixels in the images of the successive views. In the techniques described in this disclosure, the color components of the identified pixels in the images of the three views are each different color components (e.g., red-component for pixel from image of first view, green-component for pixel from image of second view, and blue-component for pixel from image of third view).

In the example of FIG. 2A, to determine the view to which the view index value refers and to determine the next two successive views, fragment shader 36A may execute branching instructions. For instance, fragment shader 36A may execute one branching instruction per view. As described above, a branching instruction is an instruction in which there are different options for the next instruction that is executed. In addition, for each branching instruction, fragment shader 36A may need to execute three read instructions, one for each corresponding image of the three successive views.

The following pseudo-code illustrates the branching instructions, with the three read instructions for fragment shader 36A:

```
determine pixel position value of a pixel in the autostereoscopy image;
view index value = (pixel position value) modulo N;
if (view index value == 0)
{
    read red component of pixel at the pixel position value of image from
view 0;
    read green component of pixel at the pixel position value of image
from view 1;
    read blue component of pixel at the pixel position value of image
from view 2;
    combine the red, green, and blue components to generate pixel data
for the pixel in the autostereoscopy image;
}
if (view index value == 1)
{
    read red component of pixel at the pixel position value of image from
view 1;
    read green component of pixel at the pixel position value of image
from view 2;
    read blue component of pixel at the pixel position value of image
from view 3
    combine the red, green, and blue components to generate pixel data
for the pixel in the autostereoscopy image;
}
.
.
.
if (view index value == N−2)
{
    read red component of pixel at the pixel position value of image from
view N-2;
    read green component of pixel at the pixel position value of image
from view N-1;
    read blue component of pixel at the pixel position value of image
from view 0
    combine the red, green, and blue components to generate pixel data
for the pixel in the autostereoscopy image;
}
if (view index value == N−1)
{
    read red component of pixel at the pixel position value of image from
view N-1;
    read green component of pixel at the pixel position value of image
from view 0;
    read blue component of pixel at the pixel position value of image
from view 1
    combine the red, green, and blue components to generate pixel data
for the pixel in the autostereoscopy image;
}
```

In the above pseudo-code, there are N branching instructions for all possible values of the view index value. Also, for each of the branching instructions there are three read instructions (one to read the read component, one to read the green component, and one to read the blue component from corresponding images of different views).

While minimizing reads may increase efficiency generating the autostereoscopy content (e.g., pixel data for the autostereoscopy image), excessive branching instructions may potentially have negative impact on the efficiency for generating the autostereoscopy content in some examples. In the example illustrated in FIG. 2B, fragment shader 36B may execute four read instructions, thereby increase the number the read instructions as compared to fragment shader 36A, but may not need to execute any branching instructions. Accordingly, in some examples, fragment shader 36B may provide higher efficiency in generating autostereoscopy content as compared to fragment shader 36A, and in some other examples, fragment shader 36A may provide higher efficiency in generating autostereoscopy content as compared to fragment shader 36B.

As illustrated in FIG. 2B, system memory 22 includes buffer 42. Buffer 42 may comprise a two-dimensional buffer, where each storage location within the two-dimensional buffer corresponds to a pixel of the autostereoscopy image. Similar to above, the top-left storage location of the two-dimensional buffer 42 may correspond to the top-left pixel of the autostereoscopy image, the storage location to the right of the top-left storage location of the two-dimensional buffer 42 may correspond to the pixel to the right of the top-left storage location of the two-dimensional buffer 42, and so forth.

Buffer 42 may store pre-computed view index values for corresponding pixels of the autostereoscopy image. For instance, as described above with respect to FIG. 2A, fragment shader 36A may determine the view index value for a pixel of the autostereoscopy image based on its position and the number of needed views. In the example illustrated in FIG. 2B, each storage location in buffer 42 corresponds to a pixel of the autostereoscopy image, and the position of the storage location in buffer 42 may be the same as the position of the pixel to which the storage location corresponds.

In the example illustrated in FIG. 2B, a storage location in buffer 42 may store the view index value for the first view from which pixel data needs to be read for generating the pixel data for the pixel of the autostereoscopy image that corresponds to the storage location in buffer 42. Alternatively, buffer 42 may store the view index values for all three views from which pixel data needs to be read for generating the pixel data for the pixel of the autostereoscopy image that corresponds to the storage location in buffer 42.

In either of these examples, fragment shader 36B may read the view index value or values from the storage location in buffer 42. In examples where buffer 42 stores only the view index value for the first view, fragment shader 36B may be configured to determine the two successive views by adding one and two, respectively to the view index value (similar to how fragment shader 36A determines the three views based on the view index value for the first view). In examples where buffer 42 stores the view index values for all three views, fragment shader 36B may not need to perform additional operations to determine from which views pixel data is to be read.

The following pseudo-code illustrates the four read instructions for fragment shader 36B:

determine pixel position value of a pixel in the autostereoscopy image;

read view index value(s) from corresponding storage location in buffer 42;

determine the first view, second view, and third view from the view index value(s);

read red component of pixel at the pixel position value of image from first view;

read green component of pixel at the pixel position value of image from second view;

read blue component of pixel at the pixel position value of image from third view;

combine the red, green, and blue components to generate pixel data for the pixel in the autostereoscopy image.

In the above pseudo-code, fragment shader 36B may execute a first read instruction to read the view index value(s) from buffer 42. Fragment shader 36B may execute three more read instructions for reading the appropriate color components from the pixels of the corresponding images of the three views. Accordingly, fragment shader 36B may execute a four read instructions to read the color components needed to generate the pixel data for a pixel of the autostereoscopy image.

In one example, fragment shader 36B may be developed in accordance with the OpenGL ES API. One limitation of the OpenGL ES API is that fragment shader 36B cannot access a generic buffer for indexing purposes. For instance, as described above, fragment shader 36B reads view index values from buffer 42 from which fragment shader 36B determines the views from which to read pixel data. In this sense, buffer 42 stores indices that reference view index values (i.e., indices of indices). In some examples, using a generic buffer for such purposes may not be allowed in the OpenGL ES API.

However, a design around such a limitation is to use a texture buffer that is already available in the OpenGL ES API. In other words, while the OpenGL ES API may not allow buffer 42 to be a generic buffer, it may be possible to use a texture buffer that stores view index values in a similar manner as described above. For example, texture buffers generally store texture data that is mapped to portions of the rendered graphics to give the graphics a more realistic appearance. The OpenGL ES API allows access to such texture buffers. In some examples, to allow fragment shader 36B to be compliant with the OpenGL ES API, the techniques may appropriate the texture buffer for purposes of identifying the view index value(s). In these examples, buffer 42 may be a texture buffer, and the view index value(s) stored in texture buffer 42 may be stored in a similar manner as to how texture data is to be stored. Fragment shader 36B may execute instructions similar to instructions that fragment shader 36B would execute to read from a texture buffer. The difference in this case is the data that is read is not texture data, but view index value(s).

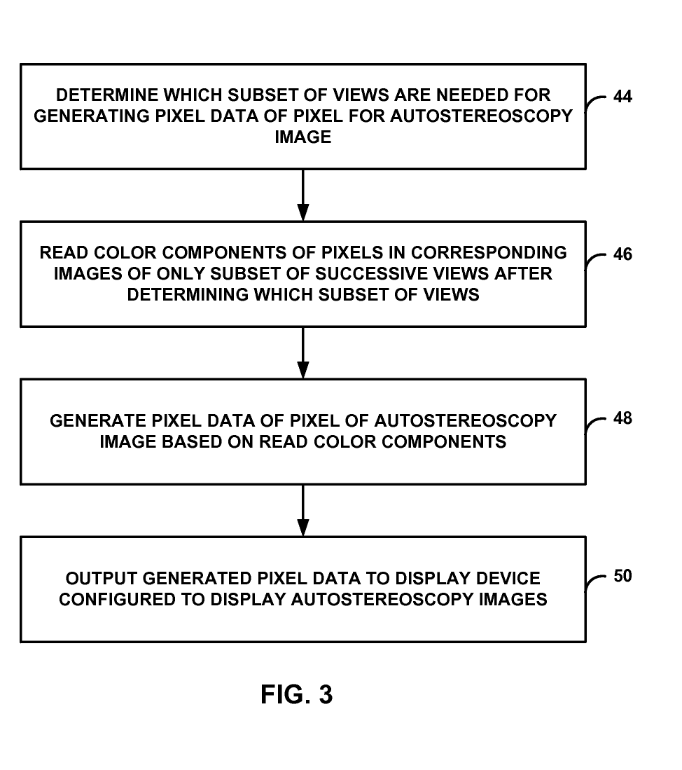

FIG. 3 is a flowchart illustrating an example technique of generating autostereoscopy content in accordance with this disclosure. GPU 20 may determine which subset of views are needed for generating pixel data of a pixel for an autostereoscopy image (44). In some examples, the subset of views needed for generating pixel data of a pixel for an autostereoscopy image may be a subset of successive views (e.g., three successive views of the eight views). Using successive views may not be necessary in every example, but for ease of description the techniques are described with respect to successive views.

As one example, to determine the subset of successive views, GPU 20, executing fragment shader 36A on shader processor 24, may determine a view index value based on a position of the pixel of the autostereoscopy image and a number of the plurality of views (e.g., by using the modulo operation to determine the remainder of the pixel position value divided by N), and may determine at least one of the subset of successive views based on the determined view index value. For instance, to determine at least one of the subset of successive views, GPU 20 may execute a branching instruction based on the determined view index value to determine which subsets of the successive views are needed for generating pixel data of the pixel of the autostereoscopy image.

As another example, to determine the subset of successive views, GPU 20, executing fragment shader 36B on shader processor 24, may read at least one view index value from a storage location of a buffer. GPU 20 may determine at least one of the subset of successive views based on the at least one view index value.

GPU 20 may read color components of pixels in corresponding images of only the subset of successive views after determining which subset of successive views are needed for generating pixel data of the pixel of the autostereoscopy image (46). For example, GPU 20, via fragment shader 36A or fragment shader 36B, may read a first color component (e.g., red component) of a pixel in an image of a first view of the successive views, a second color component (e.g., green component) of a pixel in an image of a second view of the successive views, and a third color component (e.g., blue component) of a pixel in an image of a third view of the successive views.

GPU 20 may generate pixel data of the pixel of the autostereoscopy image based on the read color components (48). For example, GPU 20, via fragment shader 36A or fragments shader 36B, may set the first color component of a pixel in an image of a first view as a first color component of the pixel of the autostereoscopy image, set the second color component of a pixel in an image of a second view as a second color component of the pixel of the autostereoscopy image, and set the third color component of a pixel in an image of a third view as a third color component of the pixel of the autostereoscopy image.

Device 12 may output the generated pixel data to a display device configured to display autostereoscopy images (50). For example, GPU 20 generates the pixel data for all of the pixels of the autostereoscopy image and stores the pixel data in frame buffer 40. Device 12 may output the pixel data of the autostereoscopy image (e.g., the autostereoscopy content) to display device 14 via computer-readable medium 16 (e.g., an HDMI cable).

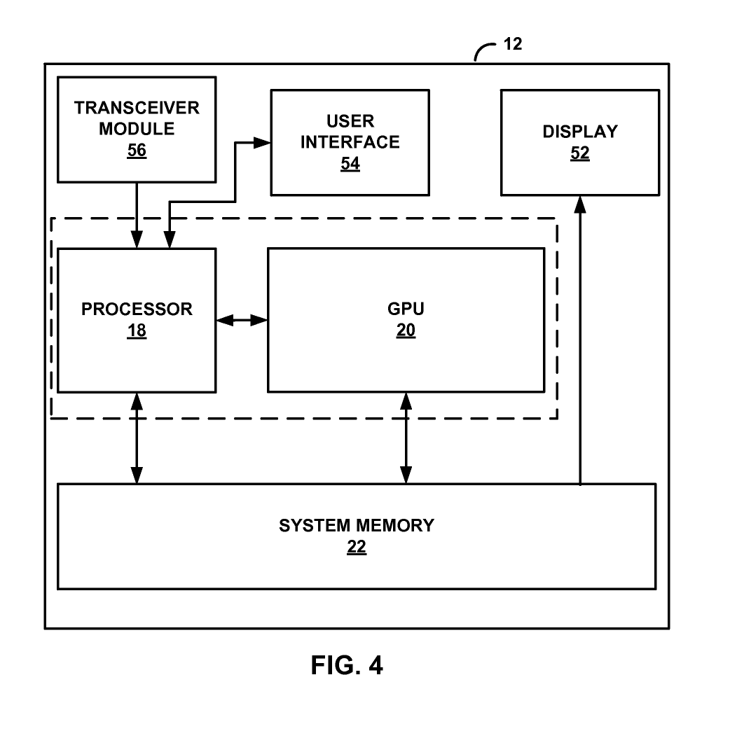

FIG. 4 is a block diagram illustrating a device of FIG. 1 in further detail. For example, FIG. 4 further illustrates device 12 in further detail. As described above, examples of device 12 include, but are not limited to, wireless devices, mobile telephones, personal digital assistants (PDAs), video gaming consoles that include video displays, mobile video conferencing units, laptop computers, desktop computers, television set-top boxes, tablet computing devices, e-book readers, and the like. In the example of FIG. 4, device 12 includes processor 18, GPU 20, and system memory 22. In the example illustrated in FIG. 4, processor 18 and GPU 20 are illustrated in dashed lines to indicate that processor 18 and GPU 20 may be formed in the same integrated circuit. In some examples, processor 18 and GPU 20 may be formed in other integrated circuits (i.e., be in different chips). Processor 18, GPU 20, and system memory 22 are described with respect to FIG. 1 and not described further in FIG. 4.

Device 12 may also include display 52, user interface 54, and transceiver module 56. For example, although the techniques described in this disclosure are described with respect to device 12 outputting the autostereoscopy content to display device 14, in some examples, device 12 may also output the autostereoscopy images to display 52. If display 52 is configured to display autostereoscopy images, display 52 may display the autostereoscopy images instead of display device 14. In some examples, even if display 52 is not configured to display autostereoscopy content, display 52 may still display the autostereoscopy content along with display device 14. In these examples, the viewer will not experience autostereoscopy effect by viewing display 52, but will experience autostereoscopy effect by viewing display device 14.

Device 12 may include additional modules or units not shown in FIG. 4 for purposes of clarity. For example, device 12 may include a speaker and a microphone, neither of which are shown in FIG. 4, to effectuate telephonic communications in examples where device 12 is a mobile wireless telephone. Furthermore, the various modules and units shown in device 12 may not be necessary in every example of device 12. For example, user interface 54 and display 52 may be external to device 12 in examples where device 12 is a desktop computer. As another example, user interface 54 may be part of display 52 in examples where display 52 is a touch-sensitive or presence-sensitive display of a mobile device.

Examples of user interface 54 include, but are not limited to, a trackball, a mouse, a keyboard, and other types of input devices. User interface 54 may also be a touch screen and may be incorporated as a part of display 52. Transceiver module 56 may include circuitry to allow wireless or wired communication between device 12 and another device or a network. Transceiver module 56 may include modulators, demodulators, amplifiers and other such circuitry for wired or wireless communication. For example, transceiver module 56 of device 12 may couple to computer-readable medium 16 to allow device 12 to display autostereoscopy content on display device 14.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of generating autostereoscopy content, the method comprising:
determining which subset of views from a plurality of views is needed for generating pixel data of a pixel of an autostereoscopy image;
reading color components of pixels in corresponding images of only the subset of views after determining which subset of views is needed for generating pixel data of the pixel of the autostereoscopy image; and
generating, based on the read color components of the pixels in the corresponding images of the subset of views, the pixel data of the pixel of the autostereoscopy image.

2. The method of claim 1, wherein determining which subset of views is needed comprises:
determining which subset of successive views from the plurality of views is needed for generating pixel data of the pixel of the autostereoscopy image, wherein the subset of successive views comprise views with least amount of change in disparity in a particular direction compared to all other views.

3. The method of claim 1, wherein determining which subset of views is needed comprises:
determining, based on a position of the pixel of the autostereoscopy image and a number of the plurality of views, a view index value; and
determining, based on the determined view index value, at least one view of the subset of views.

4. The method of claim 3, wherein determining at least one view of the subset of views comprises:
executing a branching instruction based on the determined view index value to determine which subset of the views are needed for generating pixel data of the pixel of the autostereoscopy image.

5. The method of claim 1, wherein determining which subset of views is needed comprises:
reading at least one view index value from a storage location of a buffer; and
determining at least one view of the subset of views based on the at least one view index value.

6. The method of claim 1, wherein reading color components of pixels in corresponding images comprises:
reading a first color component of a pixel in an image of a first view;
reading a second color component of a pixel in an image of a second view; and
reading a third color component of a pixel in an image of a third view.

7. The method of claim 6, wherein generating the pixel data of the pixel of the autostereoscopy image comprises:
setting the first color component as a first color component of the pixel of the autostereoscopy image;
setting the second color component as a second color component of the pixel of the autostereoscopy image; and
setting the third color component as a third color component of the pixel of the autostereoscopy image.

8. The method of claim 1, further comprising:
outputting the generated pixel data to a display device configured to display autostereoscopy images.

9. The method of claim 1,
wherein determining which subset of views comprises determining, by a graphics processing unit (GPU) of a mobile device, which subset of views from the plurality of views is needed for generating the pixel data of the pixel of the autostereoscopy image,
wherein reading color components of pixels comprises reading, by the GPU of the mobile device, the color components of pixels in the corresponding images of only the subset of views after determining which subset of views is needed for generating pixel data of the pixel of the autostereoscopy image, and
wherein generating the pixel data comprises generating, by the GPU of the mobile device, the pixel data of the pixel of the autostereoscopy image based on the read color components.

10. A device for generating autostereoscopy content, the device comprising:
a memory configured to store images of a plurality of views; and
a graphics processing unit (GPU) configured to:
determine which subset of views from a plurality of views is needed for generating pixel data of a pixel of an autostereoscopy image;
read color components of pixels in corresponding images of only the subset of views after determining which subset of views is needed for generating pixel data of the pixel of the autostereoscopy image; and
generate, based on the read color components of the pixels in the corresponding images of the subset of views, the pixel data of the pixel of the autostereoscopy image.

11. The device of claim 10, wherein, to determine which subset of views is needed, the GPU is configured to:
determine which subset of successive views from the plurality of views is needed for generating pixel data of the pixel of the autostereoscopy image, wherein the subset of successive views comprise views with least amount of change in disparity in a particular direction compared to all other views.

12. The device of claim 10, wherein, to determine which subset of views from the plurality of views are needed for generating pixel data of the pixel of the autostereoscopy image, the GPU is configured to:
determine, based on a position of the pixel of the autostereoscopy image and a number of the plurality of views, a view index value; and
determine, based on the determined view index value, at least one view of the subset of views.

13. The device of claim 12, wherein, to determine at least one view of the subset of views, the GPU is configured to:
execute a branching instruction based on the determined view index value to determine which subset of the views are needed for generating pixel data of the pixel of the autostereoscopy image.

14. The device of claim 10, wherein, to determine which subset of views from the plurality of views needed for generating pixel data of the pixel of the autostereoscopy image, the GPU is configured to:
read at least one view index value from a storage location of a buffer; and
determine at least one view of the subset of views based on the at least one view index value.

15. The device of claim 10, wherein, to read color components of pixels in corresponding images, the GPU is configured to:
read a first color component of a pixel in an image of a first view;
read a second color component of a pixel in an image of a second view; and
read a third color component of a pixel in an image of a third view.

16. The device of claim 15, wherein, to generate the pixel data of the pixel of the autostereoscopy image, the GPU is configured to:
set the first color component as a first color component of the pixel of the autostereoscopy image;
set the second color component as a second color component of the pixel of the autostereoscopy image; and
set the third color component as a third color component of the pixel of the autostereoscopy image.

17. The device of claim 10, wherein the device is configured to:
output the generated pixel data to a display device configured to display autostereoscopy images.

18. The device of claim 10, wherein the device comprises a mobile device.

19. A computer-readable storage medium having instructions stored thereon that when executed cause a graphics processing unit (GPU) of a device for generating autostereoscopy content to:
determine which subset of successive views from a plurality of views is needed for generating pixel data of a pixel of an autostereoscopy image, wherein the subset of successive views comprise views with least amount of change in disparity in a particular direction compared to all other views;
read color components of pixels in corresponding images of only the subset of successive views after determining which subset of successive views is needed for generating pixel data of the pixel of the autostereoscopy image; and
generate, based on the read color components of the pixels in the corresponding images of the subset of successive views, the pixel data of the pixel of the autostereoscopy image.

20. The computer-readable storage medium of claim 19, wherein the instructions that cause the GPU to determine which subset of successive views from the plurality of views are needed for generating pixel data of the pixel of the autostereoscopy image comprise instructions that cause the GPU to:
determine, based on a position of the pixel of the autostereoscopy image and a number of the plurality of views, a view index value; and
determine, based on the determined view index value, at least one view of the subset of successive views.

21. The computer-readable storage medium of claim 19, wherein the instructions that cause the GPU to determine which subset of successive views from the plurality of views are needed for generating pixel data of the pixel of the autostereoscopy image comprise instructions that cause the GPU to:
read at least one view index value from a storage location of a buffer; and
determine at least one view of the subset of successive views based on the at least one view index value.

22. A device for generating autostereoscopy content, the device comprising:
a memory configured to store images of a plurality of view; and
a graphics processing unit (GPU) comprising:
means for determining which subset of successive views from a plurality of views is needed for generating pixel data of a pixel of an autostereoscopy image, wherein the subset of successive views comprise views with least amount of change in disparity in a particular direction compared to all other views;
means for reading color components of pixels in corresponding images of only the subset of successive views after determining which subset of successive views is needed for generating pixel data of the pixel of the autostereoscopy image; and
means for generating, based on the read color components of the pixels in the corresponding images of the subset of successive views, the pixel data of the pixel of the autostereoscopy image.
